(19) United States
(12) Patent Application Publication
(10) Pub. No.: US 2011/0010179 A1
(43) Pub. Date: Jan. 13, 2011

(54) VOICE SYNTHESIS AND PROCESSING

(76) Inventor: Devang K. Naik, San Jose, CA (US)

Correspondence Address: APPLE INC./BSTZ;BLAKELY SOKOLOFF TAYLOR & ZAFMAN LLP, 1279 OAKMEAD PARKWAY, SUITE 300, SUNNYVALE, CA, 94085-4040, US

(21) Appl. No.: 12/502,015

(22) Filed: Jul. 13, 2009

(51) Int. Cl. G10L 13/00; G10L 21/00

(52) U.S. Cl. 704/262; 704/258; 704/270; 704/E13.001; 704/E21.001

(57) ABSTRACT

A method and an apparatus for voice synthesis and processing have been presented. In one exemplary method, a first audio recording of a human speech in a natural language is received. Then speech analysis synthesis algorithm is applied to the first audio recording to synthesize a second audio recording from the first audio recording such that the second audio recording sounds humanistic and consistent, but unintelligible.

### TECHNICAL FIELD

This disclosure generally relates to voice synthesis and processing, and more particularly, to synthesizing humanistic and consistent, but unintelligible, voices.

### BACKGROUND

Audio synthesis techniques have been used in entertainment industries and computing industries for many applications. For example, special effects may be added to audio recordings to enhance the sound tracks in motion pictures, television programs, video games, etc. Artists often desire to create exotic and interesting sounds and voices to use with non-human characters in motion pictures, such as aliens, monsters, robots, animals, etc.

Conventionally, studios hire people whose native language is an exotic language, such as Tibetan, as voice artists to record lines in a motion picture. Then the voice recordings may be further processed to produce a voice for the non-human characters. However, in a motion picture that includes many non-human characters, it is expensive to hire so many voice artists.

### SUMMARY OF THE DESCRIPTION

In one embodiment, a first audio recording of a human speech in a natural language is received. Speech analysis synthesis algorithm is applied to the first audio recording to synthesize a second audio recording from the first one such that the second audio recording sounds humanistic and consistent, but unintelligible. In some embodiments, intelligent analysis synthesis is applied, rather than pure analysis synthesis. Furthermore, the intonation of the human speech in the first audio recording is preserved through the speech analysis synthesis in order to retain the semantic as well as communicative aspects of human language. The second audio recording may be used in various artistic creation, such as in a movie sound track, a video game, etc.

Another aspect of this description relates to voice synthesis and processing. A first audio recording received may be divided into multiple abstract sound units, such as phoneme segments, syllables, or polysyllabic units, etc. Then each of the abstract sound units may be reversed to generate a second audio recording. To further improve the quality of the second audio recording, the discontinuities at the junctions of consecutive abstract sound units are smoothed. The second audio recording may be stored and/or played.

### BRIEF DESCRIPTION OF THE DRAWINGS

The present invention is illustrated by way of example and not limitation in the figures of the accompanying drawings in which like references indicate similar elements.

FIG. 1 is a flow chart of an example of a method to generate an audio recording that sounds humanistic and consistent, but unintelligible, according to one embodiment of the invention.

FIG. 2 is a flow chart of an example of a method to synthesize voice according to one embodiment of the invention.

FIG. 3 is a block diagram showing an example of a voice synthesizer according to one embodiment of the invention.

FIG. 4 is a spectrogram of an exemplary audio recording made by a person.

FIG. 5 is a spectrogram of an audio recording synthesized from the exemplary audio recording of FIG. 4 according to one embodiment of the invention.

FIG. 6 shows an example of a data processing system which may be used in at least some embodiments of the invention.

### DETAILED DESCRIPTION

Various embodiments and aspects of the inventions will be described with reference to details discussed below, and the accompanying drawings will illustrate the various embodiments. The following description and drawings are illustrative of the invention and are not to be construed as limiting the invention. Numerous specific details are described to provide a thorough understanding of various embodiments of the present invention. However, in certain instances, well-known or conventional details are not described in order to provide a concise discussion of embodiments of the present inventions.

Reference in the specification to one embodiment or an embodiment means that a particular feature, structure or characteristic described in connection with the embodiment is included in at least one embodiment of the invention. The appearance of the phrase “in one embodiment” in various places in the specification do not necessarily refer to the same embodiment.

Some portions of the detailed descriptions below are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission, or display devices.

The present invention also relates to apparatus for performing the operations herein. This apparatus may be specially constructed for the required purposes, or it may comprise a general-purpose computer selectively activated or reconfigured by a computer program stored in the computer. Such a computer program may be stored in a machine-readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the required operations. The required structure for a variety of these systems will appear from the description below. In addition, the present invention is not described with reference to any particular programming language. It will be appreciated that a variety of programming languages may be used to implement the teachings of the invention as described herein.

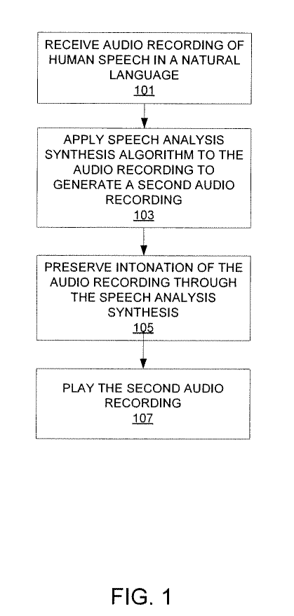

FIG. 1 is a flow chart of an example of a method to generate an audio recording that sounds humanistic, consistent, yet unintelligible, according to one embodiment of the invention. The method may be performed by hardware, software, firmware, or a combination of the above.

In some embodiments, an audio recording of a human speech in a natural language is received in operation 101. A natural language as used herein generally refers to a language written or spoken by humans for general-purpose communication, as opposed to constructs, such as computer-programming languages, machine-readable or machine-executable languages, or the languages used in the study of formal logic, such as mathematical logic. Some examples of a natural language include English, German, French, Russian, Japanese, Chinese, etc.

In operation 103, speech analysis synthesis algorithm is applied to the audio recording received to generate a second audio recording. In some embodiments, intelligent speech analysis synthesis is applied, rather than pure analysis synthesis. The speech analysis synthesis may be performed at the sound level to render the result unintelligible yet representing an unevolved language, while retaining the humanistic characteristics of the audio recording. In some embodiments, the intonation of the audio recording is preserved through the speech analysis synthesis at operation 105.

Upon completion of the speech analysis synthesis, the second audio recording is played in operation 107. The second audio recording may sound similar to the audio recording received in terms of intonation and other humanistic characteristics. However, unlike the audio recording received in the natural language, the second audio recording is unintelligible yet consistent. It may be difficult to decipher what is being said by simply listening to the second audio recording. The second audio recording may be useful in many applications. For example, the second audio recording may be used as the voice of non-human characters (e.g., aliens, monsters, animals, etc.) in motion pictures, video games, etc., by synchronizing the second audio recording with a display of the non-human characters. The humanistic characteristics in the second audio recording make it sound like a real speech, while the unintelligibility of the second audio recording is suitable for mimicking non-human language. Alternatively, the above approach may be used in combination with other voice or speech encrypting techniques to encrypt the voice recording received in order to strengthen the encryption. In some embodiments, the above voice synthesis technique may be used with an instant messaging application, such as iChat provided by Apple Inc. of Cupertino, Calif. In one example, the above technique may be used with text chat that is synthesized with alien voice effect. Specifically, text-to-speech synthesis may be applied to the text entered via text chat, following which the above technique may be applied to the speech synthesized to generate an unintelligible, yet consistent spoken content related to the text entered. In another example, the above technique may be used with audio chat, where part of a single speaker's speech is analyzed and rendered into an unevolved spoken dialog to produce the effect of a conversation between two speakers. For instance, the speech may be analyzed and divided into abstract sound units using automatic speech recognition. Subsequently, the above approach is applied to generate an unintelligible, yet consistent rendition of the speaker's voice, that retains the vocal characteristics and intonation of the speaker, but renders it unintelligible.

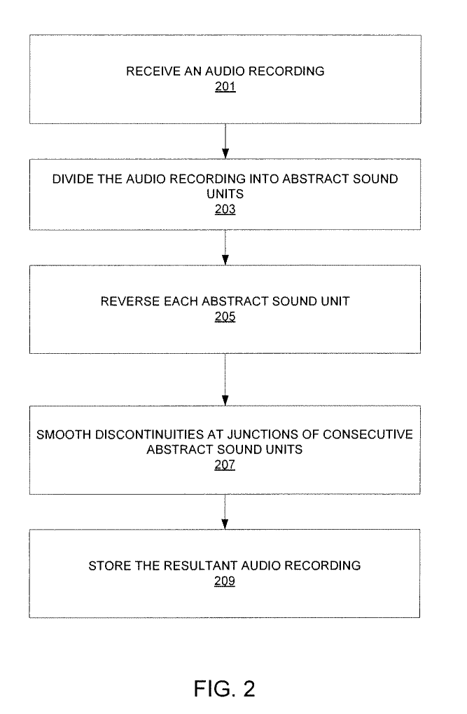

FIG. 2 is a flow chart of an example of a method to synthesize voice according to one embodiment of the invention. The method may be performed by hardware, software, firmware, or a combination of the above.

In some embodiments, an audio recording is received in operation 201. In operation 203, the audio recording is divided into abstract sound units, such as phoneme segments, syllables, polysyllabic units, etc. In human language, a phoneme is the smallest linguistically distinctive unit of sound. Phonemes carry no semantic content themselves. In other words, the audio recording is segmented on the sound level in the time domain. Each phoneme segment contains one or more formants, which is, in general, a characteristic component of the quality of a speech sound. Specifically, a formant may include several resonance bands held to determine the phonetic quality of a vowel. In some embodiments, a speech recognition algorithm is used to identify the boundaries between phoneme segments automatically. In addition to, or as an alternative to, using speech recognition algorithm, a user, such as a phonetician or linguist in the language of the original recording, may listen to the audio recording and manually identify the boundaries of the phoneme segments. The determined phonetic segments may also be combined to form syllabic or polysyllabic units prior to applying the reversal.

In operation 205, each abstract sound unit is reversed. For example, the formants within each abstract sound unit are re-arranged in the opposite chronological order. Because each abstract sound unit has been reversed, the junctions between two consecutive abstract sound units may not be continuous. As a result, the transition from one sound unit to the next sound unit may not be smooth. Therefore, to improve the quality of the output audio recording, the discontinuities at the junctions between two consecutive abstract sound units are smoothed in operation 207. Smoothing of discontinuities may be driven by signal processing or finding abstract sound units intelligently such that the articulation aspects of the reversed units retain a smoother representation. For example, the nasal sound “n” when followed by the vowel sound “AA” as in “bar” may be reversed, where as the nasal sound “n” when followed by a consonant sound “d” as in the word “bend” may not be reversed. In some embodiments, one or more transformations in the frequency domain, such as Fourier transform, linear predictive coding (LPC), interpolation, etc., are applied to the formants at or near the junctions between two consecutive abstract sound units to smooth the discontinuities. For instance, the formants may be parameterized by LPC, and then the size of the formants may be reset to smooth the transition from one abstract sound unit to the next abstract sound unit. In some embodiments, additional audio processing techniques, such as crossfading, interpolate repair, etc., may be applied to further improve the quality of the output audio recording.

In some embodiments, the abstract sound units in the audio recording may be intelligently selected to form groups for reversal. Specifically, one or more abstract sound units in the audio recording may be intelligently selected to form a group, which is then reversed. For example, once phoneme syllable alignment is done, points at which reversal can be done to minimize discontinuities of the resultant audio recording are marked. As such, a combination of phoneme segments may be reversed in the audio recording, while several syllables may be reversed at other places in the same audio recording.

After the discontinuities have been smoothed, the resultant audio recording synthesized from the audio recording received retains the humanistic characteristics of the audio recording received, but the resultant audio recording is generally unintelligible yet consistent. In operation 209, the resultant audio recording is stored in a computer-readable storage medium (e.g., a hard disk, a compact disk, etc.).

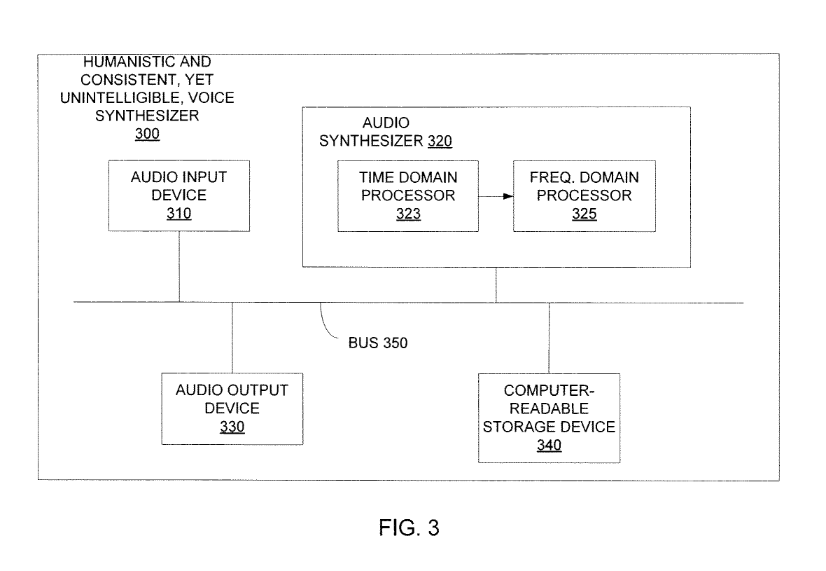

FIG. 3 is a block diagram showing an example of a humanistic and unintelligible, yet consistent, voice synthesizer according to one embodiment of the invention. The voice synthesizer may be implemented by hardware (e.g., special-purpose circuits, general-purpose machines, such as personal computer, server, etc.), software, firmware, or a combination of any of the above. An exemplary computer system usable to implement the voice synthesizer in some embodiments is shown in details below.

In some embodiments, the humanistic and consistent, yet unintelligible, voice synthesizer 300 includes an audio input device (e.g., microphone) 310, an audio synthesizer 320, an audio output device (e.g., speaker) 330, and a computer-readable storage medium 340, coupled to each other via a bus 350. The audio input device 310 is operable to receive analog and/or digital audio input, which may include a speech, a conversation, etc. In addition to the audio input device 310, the voice synthesizer 300 further includes the audio output device 330 to play a synthesized audio recording or to output the audio signals of the synthesized audio recording to another device.

The voice synthesizer 300 further includes a computer-readable storage device 340, usable to store data and/or code. The computer-readable storage device 340 may include one or more computer-readable storage media, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing data and/or code. In some embodiments, the computer-readable storage device 340 stores the audio recording received via the audio input device 310 as well as the synthesized audio recording. In addition, the computer-readable storage device 340 may store code, such as machine-executable instructions, which when executed by the audio synthesizer 320, causes the audio synthesizer 320 to perform various operations as discussed below.

In some embodiments, the audio synthesizer 320 includes a time domain processor 323 and a frequency domain processor 325. Each of the time domain processor 323 and frequency domain processor 325 may include one or more general-purpose processing devices (e.g., microcontrollers) and/or special-purpose processing devices (e.g., special-purpose semiconductor circuits, like analog-to-digital converters). In general, the time domain processor 323 processes the audio recording received in time domain, while the frequency domain processor 325 processes the output from the time domain processor 323 in the frequency domain. For example, in one embodiment, the time domain processor 323 converts the audio recording received from analog format to digital format, and then divides the digital audio recording into abstract sound units. As such, the digital audio recording can be further processed on the sound level. The time domain processor 323 may further reverse the formants in each of the abstract sound units. In other words, the time domain processor 323 may rearrange the formants in each abstract sound unit in a chronologically reversed order. After reversing each abstract sound unit, there may be discontinuities at the junctions of consecutive abstract sound units. In order to improve the quality of the output audio recording, these discontinuities are smoothed in some embodiments using frequency domain processing.

As discussed above, the audio synthesizer 320 also includes the frequency domain processor 325. When the frequency domain processor 325 receives the reversed audio recording from the time domain processor 323, the frequency domain processor 325 may apply one or more frequency domain transformations to the reversed audio recording to smooth the discontinuities at the junctions of consecutive abstract sound units. For instance, the frequency domain processor 325 may apply linear predictive coding, Fourier transform, etc., to the sound or formants at the junctions of consecutive abstract sound units in order to smooth the discontinuities. When the frequency domain processor 325 is done processing the reversed audio recording, the frequency domain processor 325 may output the resultant audio recording via the bus 350 to the audio output device 330, which may play the resultant audio recording. Alternatively, the frequency domain processor 325 may output the resultant audio recording via the bus 350 to the computer-readable storage device 340 to be stored thereon.

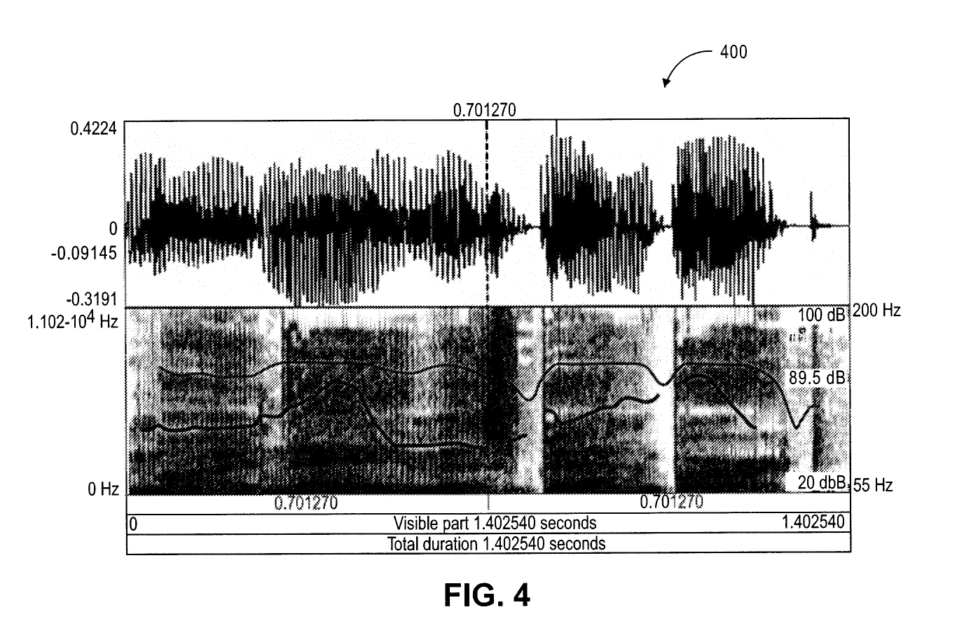

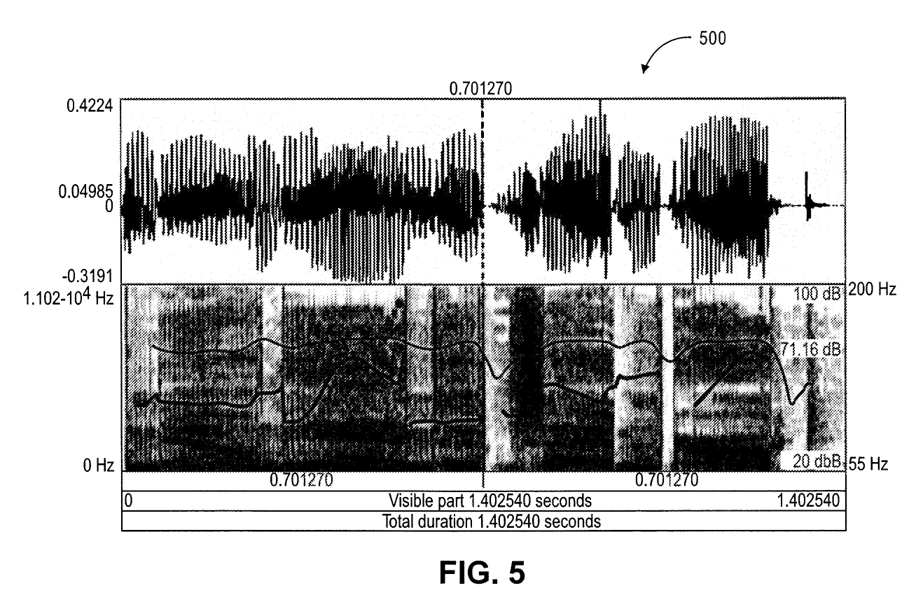

FIG. 4 is a spectrogram of an exemplary audio recording made by a person. FIG. 5 is a spectrogram of an audio recording synthesized from the exemplary audio recording 400 of FIG. 4 according to one embodiment of the invention. The spectrogram 400 in FIG. 4 shows the digital signals representing a speech made by the person. In the current example, the spectrogram is divided into abstract sound units and the formants in each abstract sound unit are reversed. Then the formants at the junctions of consecutive abstract sound units are smoothed by interpolate repair to generate the synthesized audio recording 500 illustrated in FIG. 5. The synthesized audio recording 500 may still sound humanistic and consistent, albeit unintelligible. As such, the synthesized audio recording 500 may be used as the voice of non-human characters (e.g., aliens, animals, etc.) in movies, games, cartoons, etc.

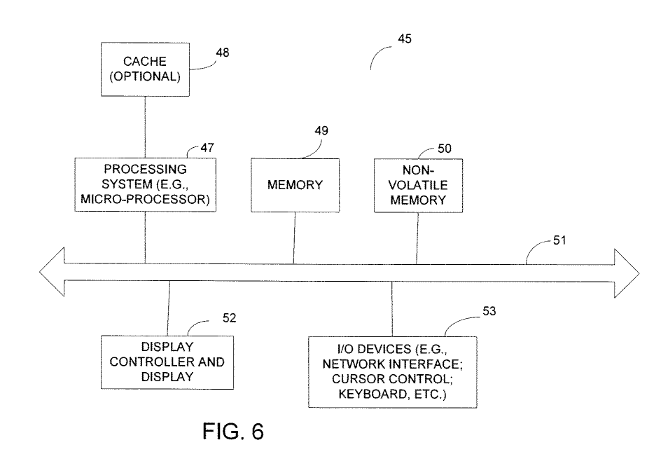

FIG. 6 shows one example of a typical computer system, which may be used with the present invention. Note that while FIG. 6 illustrates various components of a computer system, it is not intended to represent any particular architecture or manner of interconnecting the components as such details are not germane to the present invention. It will also be appreciated that personal digital assistants (PDAs), cellular telephones, handheld computers, media players (e.g. an ipod), entertainment systems, devices which combine aspects or functions of these devices (e.g. a media player combined with a PDA and a cellular telephone in one device), an embedded processing device within another device, network computers, a consumer electronic device, and other data processing systems which have fewer components or perhaps more components may also be used with or to implement one or more embodiments of the present invention. The computer system of FIG. 6 may, for example, be a Macintosh computer from Apple, Inc. The system may be used when programming or when compiling or when executing the software described.

As shown in FIG. 6, the computer system 45, which is a form of a data processing system, includes a bus 51, which is coupled to a processing system 47 and a volatile memory 49 and a non-volatile memory 50. The processing system 47 may be a microprocessor from Intel, which is coupled to an optional cache 48. The bus 51 interconnects these various components together and also interconnects these components to a display controller and display device 52 and to peripheral devices such as input/output (I/O) devices 53 which may be mice, keyboards, modems, network interfaces, printers and other devices which are well known in the art. Typically, the input/output devices 53 are coupled to the system through input/output controllers. The volatile memory 49 is typically implemented as dynamic RAM (DRAM) which requires power continually in order to refresh or maintain the data in the memory. The nonvolatile memory 50 is typically a magnetic hard drive, a flash semiconductor memory, or a magnetic optical drive or an optical drive or a DVD RAM or other types of memory systems which maintain data (e.g. large amounts of data) even after power is removed from the system. Typically, the nonvolatile memory 50 will also be a random access memory although this is not required. While FIG. 6 shows that the nonvolatile memory 50 is a local device coupled directly to the rest of the components in the data processing system, it will be appreciated that the present invention may utilize a non-volatile memory which is remote from the system, such as a network storage device which is coupled to the data processing system through a network interface such as a modem or Ethernet interface. The bus 51 may include one or more buses connected to each other through various bridges, controllers and/or adapters as is well known in the art.

It will be apparent from this description that aspects of the present invention may be embodied, at least in part, in software. That is, the techniques may be carried out in a computer system or other data processing system in response to its processor, such as a microprocessor, executing sequences of instructions contained in a machine-readable storage medium such as a memory (e.g. memory 49 and/or memory 50). In various embodiments, hardwired circuitry may be used in combination with software instructions to implement the present invention. Thus, the techniques are not limited to any specific combination of hardware circuitry and software nor to any particular source for the instructions executed by the data processing system. In addition, throughout this description, various functions and operations are described as being performed by or caused by software code to simplify description. However, those skilled in the art will recognize what is meant by such expressions is that the functions result from execution of the code by a processor, such as the processing system 47.

In the foregoing specification, the invention has been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

What is claimed is:

1. A machine-readable storage medium storing executable program instructions which when executed by a data processing system cause the data processing system to perform a method comprising:
receiving a first audio recording of a human speech in a natural language; and
applying speech analysis synthesis algorithm to the first audio recording to synthesize a second audio recording from the first audio recording such that the second audio recording sounds humanistic and consistent, but unintelligible.

2. The machine-readable storage medium of claim 1, wherein the method further comprises:
synchronizing the second audio recording with a video display of a non-human character.

3. The machine-readable storage medium of claim 1, wherein an intonation of the second audio recording is substantially the same as an intonation of the first audio recording.

4. The machine-readable storage medium of claim 1, wherein applying speech analysis synthesis algorithm to the first audio recording comprises:
reversing the first audio recording at sound level to generate an intermediate audio recording; and
smoothing discontinuities between consecutive sounds in the intermediate audio recording at parametric level to generate the second audio recording.

5. A computer-implemented method comprising:
dividing a first audio recording into a plurality of abstract sound units;
synthesizing a second audio recording from the first audio recording by reversing each of the plurality of abstract sound units to generate the second audio recording;
smoothing discontinuity at junctions of consecutive ones of the plurality of abstract sound units in the synthesized audio recording; and
audibly rendering the second audio recording.

6. The method of claim 5, further comprising:
applying a speech recognition algorithm to identify boundaries of the plurality of abstract sound units.

7. The method of claim 5, wherein smoothing discontinuity at junctions of consecutive ones of the plurality of abstract sound units in the synthesized audio recording comprises:
interpolating sound at the junctions of consecutive ones of the plurality of abstract sound units in the synthesized audio recording.

8. The method of claim 5, wherein smoothing discontinuity at junctions of consecutive ones of the plurality of abstract sound units in the synthesized audio recording comprises:
resetting sizes of formants at the junctions of consecutive ones of the plurality of abstract sound units in the synthesized audio recording using linear predictive coding (LPC).

9. The method of claim 5, further comprising:
encrypting the second audio recording; and
transmitting the encrypted second audio recording over a public network.

10. An apparatus comprising:
an audio input device to receive a first audio recording of a human speech in a natural language; and
an audio synthesizer to applying speech analysis synthesis algorithm to the first audio recording to synthesize a second audio recording from the first audio recording such that the second audio recording sounds humanistic and consistent, but unintelligible.

11. The apparatus of claim 10, further comprising:
an audio output device to play the second audio recording.

12. The apparatus of claim 10, wherein the audio synthesizer comprises:
a time domain processor to divide the first audio recording into a plurality of abstract sound units in time domain.

13. The apparatus of claim 12, wherein the time domain processor is operable to execute a speech recognition algorithm to identify boundaries of the plurality of abstract sound units.

14. The apparatus of claim 12, wherein the time domain processor is operable to divide the first audio recording into the plurality of abstract sound units based on user inputs.

15. The apparatus of claim 12, wherein the time domain processor is further operable to reverse a set of one or more formants in each of the plurality of abstract sound units.

16. The apparatus of claim 12, wherein the audio synthesizer further comprises:
a frequency domain processor to reset sizes of formants at junctions of consecutive ones of the plurality of abstract sound units.

17. The apparatus of claim 16, wherein the frequency domain processor is operable to perform Fourier transform to parameterize the formants at junctions of consecutive ones of the plurality of abstract sound units.

18. The apparatus of claim 16, wherein the frequency domain processor is operable to perform linear predictive code (LPC) to parameterize the formants at junctions of consecutive ones of the plurality of abstract sound units.

19. An apparatus comprising:
means for receiving a first audio recording of a human speech in a natural language; and
means for applying speech analysis synthesis algorithm to the first audio recording to synthesize a second audio recording from the first audio recording such that the second audio recording sounds humanistic and consistent, but unintelligible.

20. The apparatus of claim 19, wherein the means for applying speech analysis synthesis algorithm comprises:
means for dividing the first audio recording into a plurality of abstract sound units in time domain.

21. The apparatus of claim 20, wherein the means for applying speech analysis synthesis algorithm further comprises:
means for reversing each of the plurality of abstract sound units; and
means for smoothing junctions of consecutive ones of the plurality of abstract sound units.

22. A computer-implemented method comprising:
dividing a first audio recording into a plurality of abstract sound units;
intelligently selecting one or more of the plurality of abstract sound units to form a plurality of groups of one or more abstract sound units in the first audio recording;
reversing each of the plurality of groups to generate the second audio recording; and
audibly rendering the second audio recording.

23. The method of claim 22, further comprising:
smoothing discontinuity at junctions of consecutive ones of the plurality of groups in the second audio recording before audibly rendering the second audio recording.

24. The method of claim 22, wherein the plurality of abstract sound units comprise one or more phoneme segments and one or more syllables.
